(19) United States
(12) Patent Application Publication
(10) Pub. No.: US 2017/0103235 A1
(43) Pub. Date: Apr. 13, 2017

(54) ELECTRONIC APPARATUS

(71) Applicant: CANON KABUSHIKI KAISHA, Tokyo (JP)

(72) Inventor: Naoki Shimma, Kawasaki-shi (JP)

(21) Appl. No.: 15/280,748

(22) Filed: Sep. 29, 2016

(30) Foreign Application Priority Data
Oct. 9, 2015 (JP) 2015-201499

(51) Int. Cl. G06F 21/81; G06F 1/32; G06F 1/26; G06F 21/44

(52) U.S. Cl. CPC G06F 21/81; G06F 21/445; G06F 1/3212; G06F 1/263

(57) ABSTRACT

An electronic apparatus includes an authentication unit that performs authentication for determining whether a battery is a genuine battery, a storage unit that stores an authentication result representing a result of the authentication, a charging unit that charges the battery with power received from a power transmission device, and a control unit that controls the charging unit so that charging of the battery is started when the power transmission device is determined to be a device that satisfies a predetermined condition and the battery is authenticated to be a genuine battery. When the authentication result is stored in the storage unit, the authentication unit does not perform new authentication. When the authentication result is stored in the storage unit, the control unit controls the charging unit so that charging of the battery is started based on the stored authentication result.

### BACKGROUND

Field

Aspects of present invention generally relate to an electronic apparatus that charges a removable battery and a control method of the electronic apparatus.

Description of the Related Art

Electronic apparatuses, such as digital cameras, mobile phones, etc., that can be operated by a rechargeable battery are known. With respect to these electronic apparatuses, it is possible to charge the battery in a state in which the battery is connected to the electronic apparatus. Japanese Patent Laid-Open No. 2011-87346 describes a method for identifying a charging device and changing a battery charging condition based on an identification result.

However, the method described in Japanese Patent Laid-Open No. 2011-87346 cannot change the battery charging condition when performing battery charge with a combination of a genuine charging device and a non-genuine battery. Therefore, when charging a non-genuine battery in a condition in which the non-genuine battery is connected to an electronic apparatus, there is a risk that the safety of the electronic apparatus is lowered.

### SUMMARY

According to an aspect of the present invention, a non-genuine battery can be safely charged.

According to another aspect of the present invention, a genuine battery and a non-genuine battery can be safely charged.

According to yet another aspect of the present invention, even when an electronic apparatus charges a non-genuine battery, a charging condition can be changed.

According to an aspect of the present invention, an electronic apparatus includes an authentication unit that performs authentication for determining whether a battery is a genuine battery, a storage unit that stores an authentication result representing a result of the authentication, a charging unit that charges the battery with power received from a power transmission device, and a control unit that controls the charging unit so that charging of the battery is started when the power transmission device is determined to be a device that satisfies a predetermined condition and the battery is authenticated to be a genuine battery. The authentication unit does not perform new authentication when the authentication result is stored in the storage unit. When the authentication result is stored in the storage unit, the control unit controls the charging unit so that the charging of the battery is started based on the stored authentication result.

Further features and aspects of the present invention will become apparent from the following description of exemplary embodiments.

### BRIEF DESCRIPTION OF THE DRAWINGS

FIG. 1 is a block diagram illustrating an example of components included in an electronic apparatus 100 according to a first embodiment.

FIG. 2 is a flowchart illustrating an example of first charge control process according to the first embodiment.

FIG. 3 is a diagram illustrating an example of authentication result information according to the first embodiment.

FIG. 4 is a block diagram illustrating an example of components included in an electronic apparatus 400 according to a second embodiment.

FIG. 5 is a flowchart illustrating an example of second charge control process according to the second embodiment.

FIG. 6 is a diagram illustrating an example of authentication result information according to the second embodiment.

FIG. 7 is a block diagram illustrating an example of components included in an electronic apparatus 700 according to a third embodiment.

FIG. 8 is a diagram illustrating an example of display icons to be displayed on a display unit in the third embodiment.

### DESCRIPTION OF THE EMBODIMENTS

Exemplary embodiments, features, and aspects of the present invention will be described below with reference to the drawings. However, the aspects of the present invention are not limited to the embodiments described below.

### First Embodiment

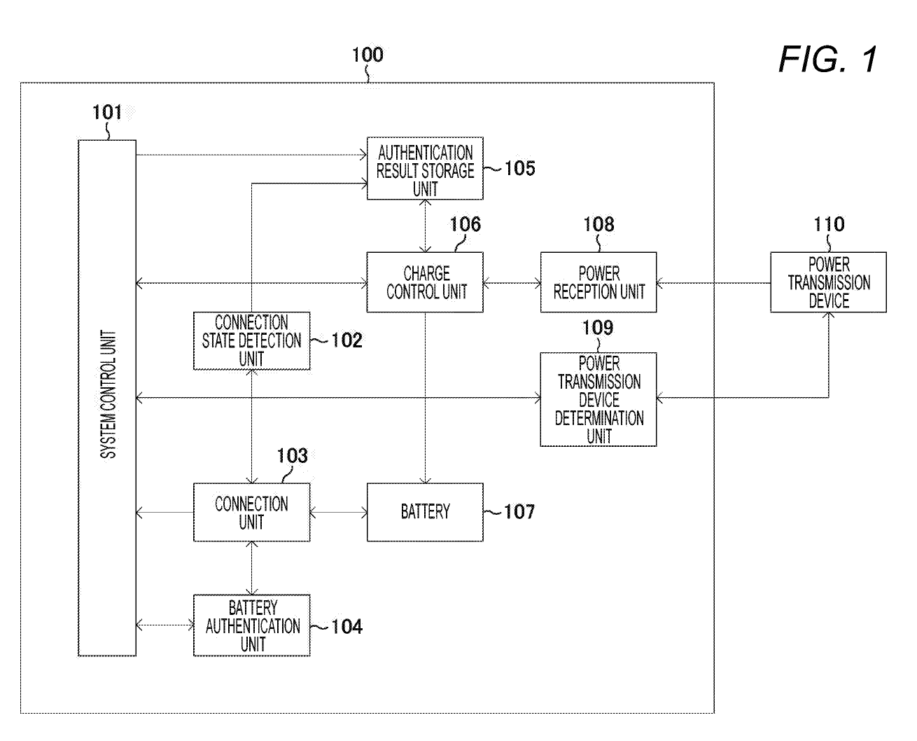

FIG. 1 is a block diagram illustrating an example of components included in an electronic apparatus 100 according to a first embodiment. The electronic apparatus 100 is, for example, an image capture device that can act as a digital camera. However, the electronic apparatus 100 is not limited to an image capture device, and can be other devices such as a mobile apparatus that can act as a mobile phone.

In FIG. 1, a system control unit 101 is a control unit that controls each component of the electronic apparatus 100 and includes, for example, a CPU (central processing unit). A connection state detection unit 102 detects a connection state of a battery 107. A connection unit 103 is a connection unit for connecting the battery 107 and includes a function to supply power obtained from the battery 107 to each component in the electronic apparatus 100.

A battery authentication unit 104 determines whether the battery 107 is a genuine battery. An authentication result storage unit 105 includes a memory for storing authentication result information indicating an authentication result determined by the battery authentication unit 104.

A charge control unit 106 charges the battery 107. The battery 107 is a battery removable from the electronic apparatus 100 and includes an authentication IC for battery authentication. The battery 107 can communicate with the charge control unit 106. A power receiving unit 108 receives power transmitted from a power transmission device 110 and supplies power obtained from the power transmission device 110 to the charge control unit 106. In the same manner as the connection unit 103, the charge control unit 106 can supply power obtained from the power receiving unit 108 to each component in the electronic apparatus 100 including the system control unit 101 in an amount necessary for each component. The charge control unit 106 can also appropriately change the magnitude of power to be supplied to each component and the magnitude of power to charge the battery 107 according to power consumption in each component in the electronic apparatus 100. This enables, for example, prioritizing power supply to each component in the electronic apparatus 100 and using surplus power to charge the battery 107.

A power transmission device determination unit 109 determines a type of the power transmission device 110. For example, when the power transmission device 110 is a device that transmits power using USB (Universal Serial Bus) bus power, the power transmission device determination unit 109 performs transmission and reception of a data signal to and from the power transmission device 110 through a USB cable and determines the type of the device. The types of the devices can include a personal computer, a USB battery charger, a printer, etc. The system control unit 101 determines the presence or absence of battery charge and a charging condition according to the type of the device and controls charging on the battery 107 by controlling the charge control unit 106.

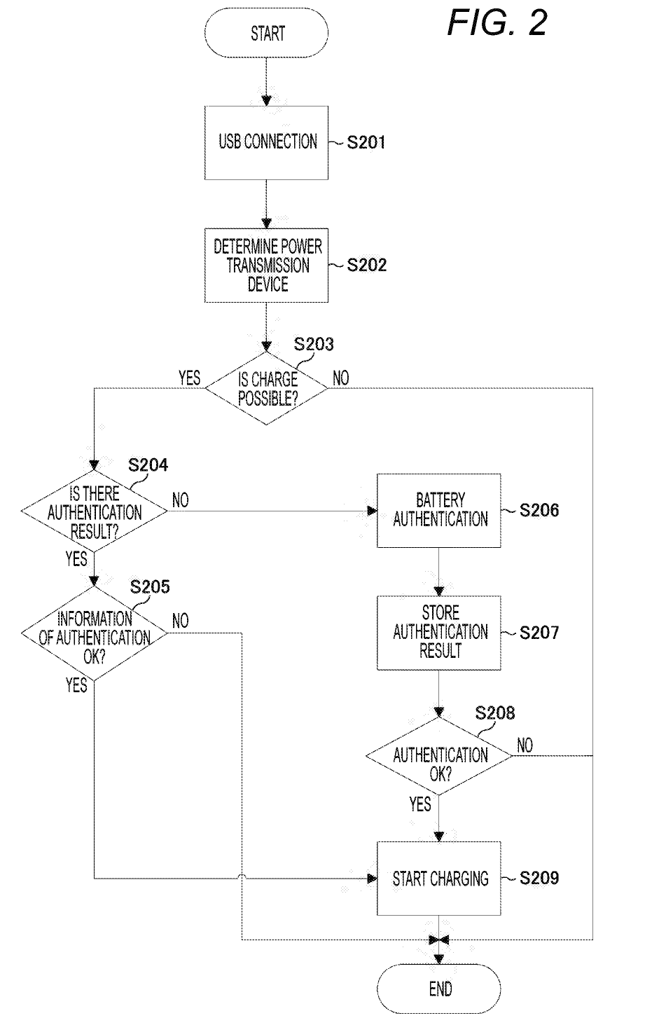

FIG. 2 is a flowchart illustrating an example of first charge control process according to the first embodiment. The first charge control process is controlled by, for example, the system control unit 101 executing a program stored in a memory in the system control unit 101. In an example shown in FIG. 2, it is assumed that power is received with USB bus power.

In S201, the system control unit 101 establishes connection between the power transmission device 110 and the electronic apparatus 100 through the USB cable. In S202, the charge control unit 106 receives power from the power receiving unit 108 and supplies power to each component of the electronic apparatus 100.

In S202, the power transmission device determination unit 109 determines the type of the power transmission device 110. As described above, the determination is performed by performing transmission and reception of a data signal to and from the power transmission device 110 through the USB cable. Specifically, for example, the power transmission device determination unit 109 transmits a request of apparatus information to the power transmission device 110 and receives the apparatus information from the power transmission device 110, so that the power transmission device determination unit 109 determines the type of the device.

In S203, the system control unit 101 acquires a determination result of the power transmission device 110 from the power transmission device determination unit 109 and determines whether the charge of the battery 107 is possible. In this process, for example, when the type of the device is a device, whose object is to charge the battery 107, such as a USB battery charger, it is determined that the charge is possible, and when the type of the device is a device, whose object is not to charge the battery 107, such as a printer, it is determined that the charge is not possible. When the system control unit 101 determines that the charge of the battery 107 is not possible (S203/No), the charge control is completed.

In the first embodiment, the system control unit 101 determines whether the charge is possible based on whether the type of the device indicates that the device is to charge a battery. It can also be determined whether the charge is possible based on whether the power transmission device 110 is a genuine power transmission device. In this case, for example, the power transmission device determination unit 109 requests an apparatus ID and the like from the power transmission device 110 and the system control unit 101 determines whether the power transmission device 110 is a genuine power transmission device from the received apparatus ID. In this way, the system control unit 101 determines that the charge is possible only when the power transmission device 110 satisfies a predetermined condition.

When the system control unit 101 determines that the charge of the battery 107 is possible (S203/Yes), in S204, the system control unit 101 verifies whether a result of authentication process is included in authentication process information stored in the authentication result storage unit 105. When the system control unit 101 verifies that the result of authentication process is not included (S204/No), in S206, the system control unit 101 controls the battery authentication unit 104 and performs authentication process with the battery 107. In S207, the system control unit 101 stores the result of the authentication process in the authentication result storage unit 105. The details of the authentication result information are described below.

Next, in S208, the system control unit 101 refers to the authentication result information stored in the authentication result storage unit 105 and determines whether the authentication process performed by the battery authentication unit 104 succeeds. The case in which the authentication process succeeds is when the battery 107 is a genuine battery, and the case in which the authentication process fails when the battery 107 is a non-genuine battery. When the system control unit 101 determines that the authentication process performed by the battery authentication unit 104 succeeds (S208/Yes), in S209, the system control unit 101 controls the charge control unit 106 to start charging the battery 107 and end the charge control. When the system control unit 101 determines that the authentication process performed by the battery authentication unit 104 fails (S208/No), the system control unit 101 does not start charging the battery 107 and ends the charge control.

When the system control unit 101 verifies that the result of authentication process is stored (S204/Yes), in S205, the system control unit 101 refers to the authentication result information stored in the authentication result storage unit 105 and determines whether the authentication process succeeds. When the system control unit 101 determines that the authentication process succeeds (S205/Yes), the system control unit 101 proceeds to S209 and starts charging the battery 107. When the system control unit 101 determines that the authentication process fails (S205/No), the system control unit 101 does not start the charging and ends the charge control. As described above, after the result of the authentication process is stored in S207, the system control unit 101 can refer to the authentication result information in S205.

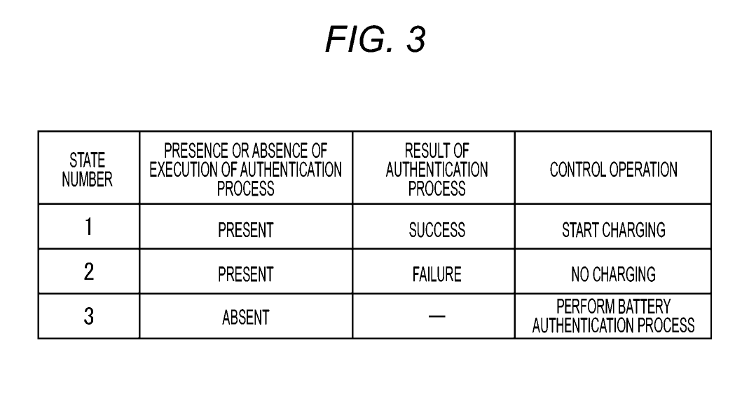

Next, the authentication result information to be stored in the authentication result storage unit 105 will be described. FIG. 3 is a diagram illustrating an example of the authentication result information according to the first embodiment. The authentication result information indicates three states related to a control operation according to the presence or absence of execution of authentication process and a result of the authentication process. The control operation of the charge is changed according to a corresponding state of the three states.

A state number 1 indicates a state in which the authentication process of the battery 107 has been performed and the authentication process succeeds. When the authentication result information stored in the authentication result storage unit 105 indicates this state, charging can start without performing the authentication process of the battery 107. A state number 2 indicates a state in which the authentication process of the battery 107 has been performed and the authentication process fails. When the authentication result information stored in the authentication result storage unit 105 indicates this state, charging of the battery 107 is not performed and the process ends. A state number 3 indicates a state in which there is not a result of the authentication process and the authentication process of the battery 107 has not yet been performed. When the authentication result information stored in the authentication result storage unit 105 indicates this state, the authentication process of the battery 107 is performed and the charge control is performed based on the authentication result of the authentication process.

The connection state detection unit 102 monitors a connection state of the battery 107 by communicating with the connection unit 103 at predetermined intervals. When the connection state detection unit 102 detects that the battery 107 is removed, the connection state detection unit 102 deletes the result of authentication process from the authentication result information stored in the authentication result storage unit 105. The timing of deleting the result of authentication process can be a time when the battery 107 is attached. In this case, information can be updated to the state number 3 in FIG. 3 instead of deleting information.

As described above, according to the first embodiment, when a battery exchange is performed, the authentication process of the battery is performed before the next charge process is started. Therefore, when the charging is started on a genuine battery and thereafter the genuine battery is replaced with a non-genuine battery, charging can be discontinued. Unless the battery is replaced, once the authentication process of the battery is performed, thereafter, charging can be controlled by referring to the authentication result information stored in the authentication result storage unit 105. This enables the authentication process of the battery to be omitted.

A method of updating the authentication result information stored in the authentication result storage unit 105 when the battery is replaced is not limited to a particular method. For example, when the authentication result storage unit 105 an SRAM (Static Random Access Memory), if power supply is discontinued, the stored authentication result information becomes an initial state due to the characteristics of the SRAM. This case is equivalent to the process that deletes the result of the authentication process from the authentication result information stored in the authentication result storage unit 105, so that it is not necessary for the connection state detection unit 102 to monitor the connection state of the battery at predetermined intervals. In addition, content of the authentication result information stored in the authentication result storage unit 105 is not limited. Any content is allowed as long as the information is related to the authentication result of the battery.

### Second Embodiment

Hereinafter, in a second embodiment, an example of an electronic apparatus that performs the charge control by considering the temperature of the battery 107 will be described.

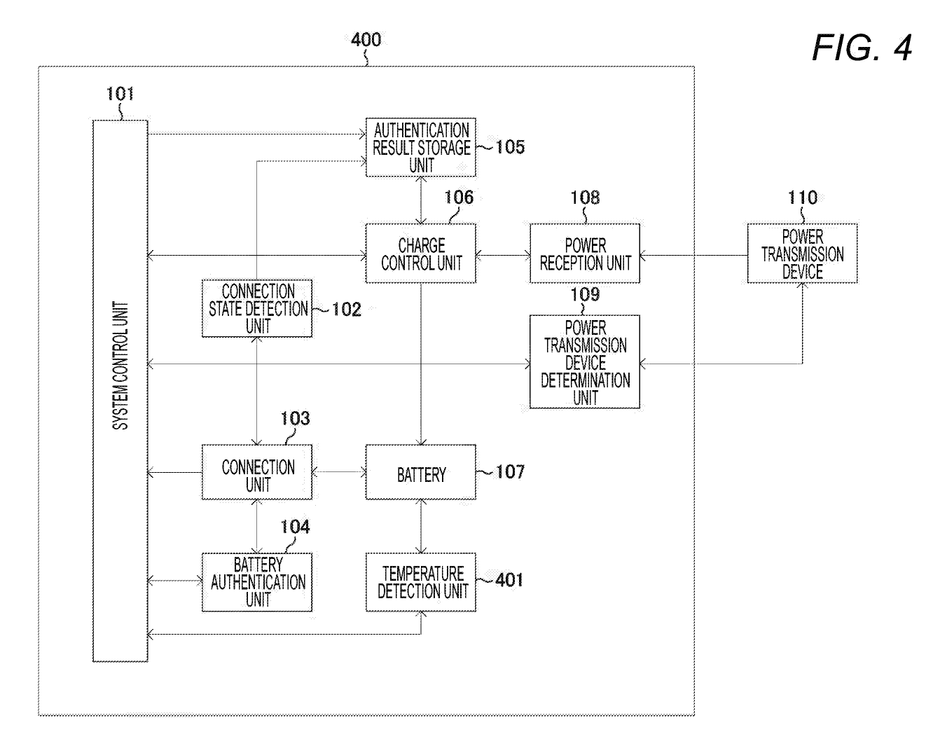

FIG. 4 is a block diagram illustrating an example of components included in an electronic apparatus 400 according to the second embodiment. In FIG. 4, the same components as those shown in FIG. 1 are denoted by the same reference numerals and the description thereof are omitted.

In FIG. 4, a temperature detection unit 401 periodically detects temperature from a thermistor of the battery 107 and transmits temperature information to the system control unit 101. When the temperature detected by the temperature detection unit 401 exceeds a predetermined temperature, the system control unit 101 can interrupt the charge performed by the charge control unit 106.

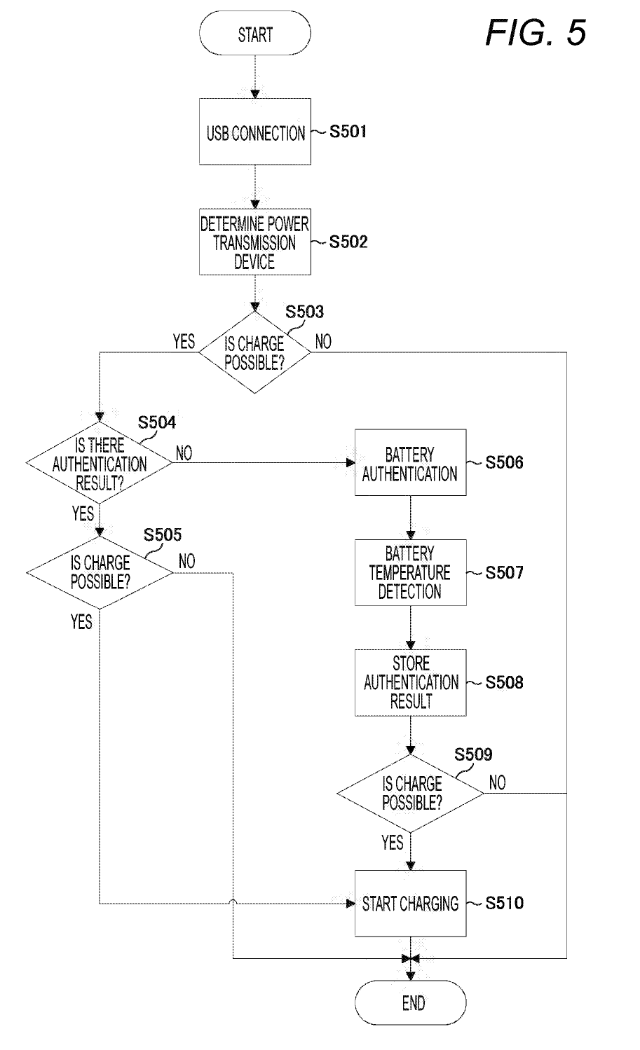

FIG. 5 is a flowchart illustrating an example of second charge control process according to the second embodiment. The second charge control process is controlled by, for example, the system control unit 101 executing a program stored in a memory in the system control unit 101. In FIG. 5, processes other than S505 and S507 to 509 are the same as the processes in FIG. 2. More specifically, S501 to S504 are the same as S201 to S204 in FIG. 2, respectively, and S506 and S510 are the same as S206 and S209 in FIG. 2, respectively. Therefore, the description of the above steps is omitted.

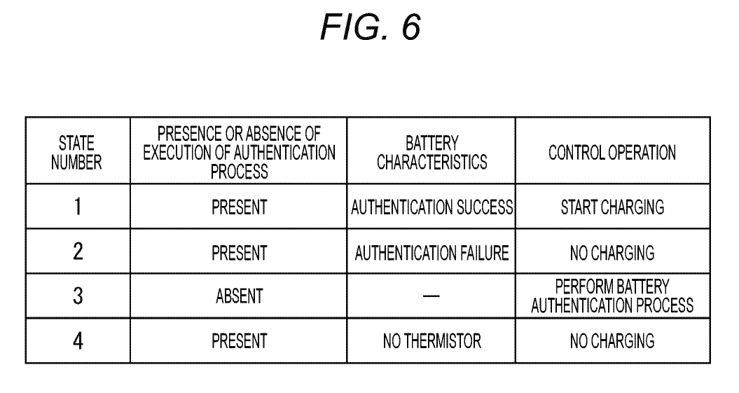

In S507, the system control unit 101 controls the temperature detection unit 401 to acquire the temperature of the battery 107. The system control unit 101 can determine whether a thermistor is mounted in the battery 107 from the acquired temperature. In S508, the system control unit 101 stores process results of S506 and S508 into the authentication result information stored in the authentication result storage unit 105. As shown in FIG. 6, in the second embodiment, the authentication result information is formed as a state in which the presence or absence of execution of authentication process and attribute information of the battery 107 (the result of authentication process and the detection result of the thermistor) are combined.

In S505 and S509, the system control unit 101 refers to the authentication result information stored in the authentication result storage unit 105 and determines whether it is a state in which charging is possible. The state numbers 1 and 2 in FIG. 6 are equivalent to the state numbers 1 and 2 in FIG. 3 and indicate a state of a case in which a thermistor is mounted in the battery 107. The state number 3 indicates a state in which there is neither the result of the authentication process nor the detection result of the thermistor and the authentication process of the battery 107 and the temperature detection process have not yet been performed.

The state number 4 indicates a state in which a thermistor cannot be detected in the battery 107. Even when the battery 107 is a genuine battery, if the thermistor mounted in the battery is malfunctioning, the temperature of the battery 107 cannot be detected. Therefore, in such a case, the battery 107 is not charged regardless of the result of the authentication process.

As described above, according to the second embodiment, charging in a state in which the temperature of the battery 107 cannot be detected can be prevented, thus enabling more secure charge control. In the second embodiment, the detection process of the temperature of the battery 107 is performed after the authentication process of the battery 107. However, the temperature of the battery 107 can be detected at any time before the process results are stored in the authentication result information in S508.

### Third Embodiment

Hereinafter, in a third embodiment, an example of an electronic apparatus including a configuration that can notify a user of a progression of a charging state and the like of the battery 107 will be described.

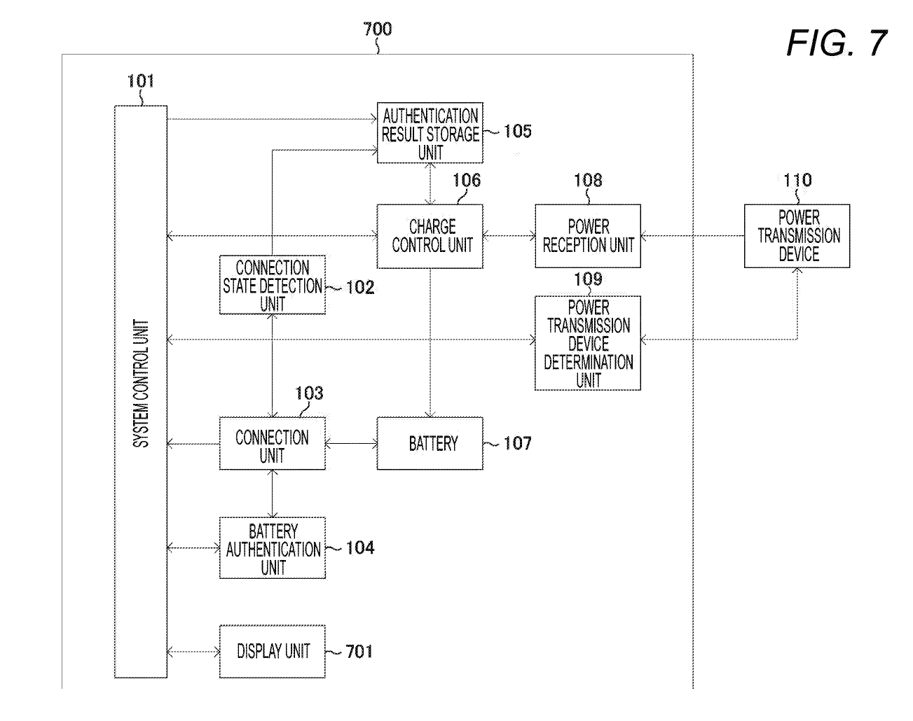

FIG. 7 is a block diagram illustrating an example of components included in an electronic apparatus 700 according to the third embodiment. In FIG. 7, the same components as those shown in FIG. 1 are denoted by the same reference numerals and the description thereof is omitted. The flow of the charge control in the third embodiment is the same as that in the first embodiment, so that the description thereof is omitted.

In FIG. 7, a display unit 701 is a liquid crystal display or the like for displaying notification content to a user.

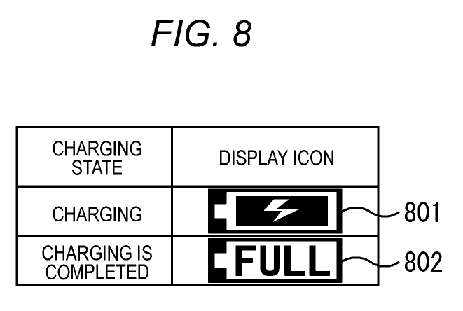

FIG. 8 is a diagram illustrating an example of display icons displayed on the display unit 701 in the third embodiment. In the third embodiment, after starting charging in S209 in FIG. 2, the system control unit 101 causes a display unit 701 to display an icon 801 indicating charging. Then, after completing the charging, the system control unit 101 causes the display unit 701 to display an icon 802 indicating completion of the charging.

As described above, in the third embodiment, a user can be notified of the charging state of the battery 107. For example, when the display unit 701 is used to just provide notification of the charging state of the battery 107, an LED (light emitting diode) whose power consumption is less than that of a liquid crystal display can be used. In this case, the charging state can be displayed by lighting, blinking, extinction, and the like of the LED. In this way, the notification method of the charging state is not limited to a particular method.

### Fourth Embodiment

In the first to the third embodiments, the system control unit 101 controls the charge control unit 106 to perform the charge control. However, the charge control unit 106 can have a charge control function itself. When such a configuration is employed, once the authentication process of the battery 107 is performed, thereafter the charge control unit 106 can start charging the battery 107 based on the authentication result information stored in the authentication result storage unit 105 without supplying power to the system control unit 101. In this case, the greater the power consumption of the system control unit 101, the higher the effect to be obtained, and greater power can be used to charge the battery 107 because it is not necessary to supply power to the system control unit 101. Thus, the time it takes to complete charging can be reduced.

The first to the third embodiments do not limit a power receiving method. In the first to the third embodiments, an example is described in which power is received from the power transmission device 110 through the USB cable. However, the power can be received using another type of cable or another type of power supply. The power receiving can be realized by applying a wireless power supply method, as represented by the Qi standard, instead of a wired power supply method.

### Fifth Embodiment

The various functions, processes, and methods described in the first to the fourth embodiments can also be realized by a program executed by a personal computer, a microcomputer, a CPU (central processing unit), and the like. Hereinafter, in a fifth embodiment, a personal computer, a microcomputer, a CPU (central processing unit), and the like are referred to as “computer X”. Furthermore, in the fifth embodiment, a program for controlling computer X and for realizing the various functions, processes, and methods described in the first to the fourth embodiments is referred to as “program Y”.

The various functions, processes, and methods described in the first to the fourth embodiments are realized by computer X executing program Y. In this case, program Y is provided to computer X through a computer-readable storage medium. The computer-readable storage medium according to the fifth embodiment includes at least any one of a hard disk device, a magnetic storage device, an optical storage device, a magneto-optical storage device, a memory card, a volatile memory, a non-volatile memory, etc. The computer-readable storage medium according to the fifth embodiment is a non-transitory storage medium.

While aspects of the present invention are described with reference to exemplary embodiments, it is to be understood that the aspects of the present invention are not limited to the exemplary embodiments. The scope of the following claims is to be accorded the broadest interpretation so as to encompass all modifications and equivalent structures.

This application claims priority from Japanese Patent Application No. 2015-201499, filed Oct. 9, 2015, which is hereby incorporated by reference herein in its entirety.

What is claimed is:

1. An electronic apparatus comprising:
an authentication unit configured to perform authentication for determining whether a battery is a genuine battery;
a storage unit configured to store an authentication result representing a result of the authentication;
a charging unit configured to charge the battery with power received from a power transmission device; and
a control unit configured to control the charging unit so that charging of the battery is started when the power transmission device is determined to be a device that satisfies a predetermined condition and the battery is authenticated to be a genuine battery,
wherein the authentication unit does not perform new authentication when the authentication result is stored in the storage unit, and
wherein when the authentication result is stored in the storage unit, the control unit controls the charging unit so that the charging of the battery is started based on the stored authentication result.

2. The electronic apparatus according to claim 1, further comprising:
a detection unit configured to delete the stored authentication result when the battery is removed from the electronic apparatus.

3. The electronic apparatus according to claim 1, further comprising:
a temperature detection unit configured to detect a temperature of the battery,
wherein the storage unit stores temperature information representing the detected temperature along with the authentication result.

4. The electronic apparatus according to claim 3, wherein when the authentication result and the temperature information are stored in the storage unit, the control unit controls the charging unit so that the charging of the battery is started based on the stored authentication result and the stored temperature information.

5. The electronic apparatus according to claim 1, further comprising:
a display unit configured to display a progression of charging performed by the charging unit.

6. The electronic apparatus according to claim 1, wherein the electronic apparatus is an image capture device.

7. The electronic apparatus according to claim 1, wherein the electronic apparatus is a mobile apparatus.

8. The electronic apparatus according to claim 7, wherein the mobile apparatus includes a mobile phone.

9. A method comprising:
performing authentication to determine whether a battery is a genuine battery;
storing an authentication result representing a result of the authentication;
determining whether a power transmission device is a device that satisfies a predetermined condition; and
charging, when the power transmission device satisfies the predetermined condition and the battery is authenticated to be a genuine battery, the battery,
wherein when the authentication result is stored, new authentication is not performed, and
when the authentication result is stored, the charging of the battery is started based on the stored authentication result.

10. A non-transitory storage medium that stores a program causing a computer to execute a method, the method comprising:
performing authentication to determine whether a battery is a genuine battery;
storing an authentication result representing a result of the authentication;
determining whether a power transmission device is a device that satisfies a predetermined condition; and
charging, when the power transmission device satisfies the predetermined condition and the battery is authenticated to be a genuine battery, the battery,
wherein when the authentication result is stored, new authentication is not performed, and
when the authentication result is stored, the charging of the battery is started based on the stored authentication result.
